(19) United States
(12) Patent Application Publication
(10) Pub. No.: US 2002/0111884 A1
(43) Pub. Date: Aug. 15, 2002

(54) Method and system for tracking assets

(76) Inventors: Jeffrey C. Groat, Edina, MN (US); David W. Meyers, Brooklyn Park, MN (US)

Correspondence Address: MERCHANT & GOULD PC, P.O. BOX 2903, MINNEAPOLIS, MN, 55402-0903, US

(21) Appl. No.: 09/954,627

(22) Filed: Sep. 17, 2001

Related U.S. Application Data
(60) Provisional application No. 60/233,615, filed on Sep. 18, 2000.

(51) Int. Cl. G06F 17/60

(52) U.S. Cl. 705/28

(57) ABSTRACT

Herein is disclosed a system and a method for managing asset tracking information related to an asset within a supply chain. The supply chain includes a plurality of supplier entities capable of accessing a centralized asset tracking datastore. The method includes recording information pertaining to an asset provided by an upstream supplier in an independent datastore. The asset is identified with a unique identification code. Next, the recorded information from the upstream supplier entity is associated with the unique identification code. Next, information pertaining to the asset provided by a downstream provider is recorded in the independent datastore. Finally, the recorded information from the downstream supplier entity is associated with the unique identification code.

### RELATED APPLICATIONS

This application claims the benefit of the filing date of U.S. Provisional Patent Application Serial No. 60/233,615 filed Sep. 18, 2000 and entitled “METHOD AND SYSTEM FOR CLIENT/SERVER SYSTEM FOR TRACKING ASSETS,” herein incorporated by reference for all that it discloses and teaches.

### FIELD OF THE INVENTION

The invention disclosed herein relates to computer-based business systems, and more particularly to a system and method for asset-based tracking and association of information.

### BACKGROUND OF THE INVENTION

Modern business entities operate based upon a premise of specialization, meaning that each business entity focuses its attention on a certain set of core value-adding activities that the entity believes embodies the spirit of its enterprise. As a result, business enterprises work together to create complex products or services for customers, each entity contributing to the end product and/or service in its own way.

In a supply chain, for example, business enterprises can work together by passing assets between cooperating enterprises, so that each enterprise can perform some value-adding operation upon or add a component to the product. An exemplary manufacturer may receive various raw materials and assemble them into an end product for sale. Raw materials and end products may be exemplary assets that flow through a supply chain. The assembled end product may then be sent to a distributor, which adds value by distributing the product to retailers, where the end product can be sold to an end user. The above example generally describes a supply chain or a product life cycle-supplier, manufacturer, distributor, retailer, and end user-with members of the supply chain receiving an asset from an “upstream” entity and/or passing an asset to a “downstream” entity.

Many other forms of supply chains exist, including those in which the assets being transferred are intangible. An example of a supply chain that passes intangible assets is an investment bank passing blocks of stock to a financial services outlet for purchase by the public.

Tracking information about assets flowing through a supply chain allows members of the supply chain to behave with knowledge regarding the activities of other members of the supply chain. With existing approaches, information regarding assets flowing through s supply chain must be derived by examining records that memorialize transactions between the various members of a given supply chain or by examining documents that record operations performed upon a given asset. In other words, transactions and operations serve as the basis upon which information is organized. To find information about a particular asset, one must be able to reconstruct the transactions in which that asset was involved and operations performed upon the asset, a tedious and difficult task. One difficulty associated with the task of reconstructing a sequence of transactions or operations is that a party not involved with the transaction or operation lacks any means by which to retrieve information regarding a transaction or operation, even if that party knows that the asset was the subject of a particular transaction or operation. Additionally, a party not involved in a transaction is unlikely to have sufficient information to discern the fact that a particular asset was the subject of a particular transaction or operation.

### SUMMARY OF THE INVENTION

The method and apparatus in accordance with the present invention solves the aforementioned problem and other problems by associating a unique identification code with an asset. As an asset traverses a supply chain, information may be stored in an independent information repository, in association with the unique identification code.

In one embodiment of the invention a method is executed in which information pertaining to the asset provided by an upstream supplier is recorded in an independent datastore. Next, the asset is identified with a unique identification code. Next, the recorded information from the upstream supplier entity is associated with the unique identification code. Next, information pertaining to the asset provided by a downstream provider is recorded in the independent datastore. Finally, the recorded information from the downstream supplier entity is associated with the unique identification code.

According to another aspect of the invention, a method is executed in which information pertaining to a first asset provided by an upstream supplier is recorded in an independent datastore. Next, the first asset is identified with a first unique identification code. Next, the recorded information from the upstream supplier entity is associated with the first unique identification code. Next, information pertaining to a second asset provided by a downstream supplier entity is recorded, wherein the second asset possesses the first asset as a constituent. Next, the second asset is identified with a second unique identification code. Next, the recorded information from the downstream supplier entity is associated with the second unique identification code. Finally, the first unique identification code is associated with the second unique identification code.

According to another aspect of the invention, a method is executed in which an asset is received an asset from an upstream supplier. Next, a unique identification code is derived from the asset. Next, information pertaining to the asset is gathered. Next, the information is associated with the unique identification code. Finally, the information, associated with the unique identification code, is transmitted to the centralized asset tracking datastore.

According to another aspect of the invention, a method is executed in which an asset is received from an upstream supplier. Next, a uniques identification code is derived from the asset. Finally, information gathered by an independent upstream supplier entity and related to the asset is retreived from a centralized asset tracking datastore based upon the unique identification code.

According to another aspect of the invention, a method is executed in which information pertaining to an asset is gathered. Next, the information, associated with the asset and independent of any particular transaction is transmitted to the centralized asset tracking datastore. Next, the asset is sent from an upstream entity to a downstream entity. Next, a unique identification code is derived from the asset. Next, downstream information pertaining to the asset is gathered. Next, downstream information is associated with the unique identification code, independent of any particular transaction. Next, the downstream information, associated with the unique identification code, is transmitted to the centralized asset tracking datastore. Finally, the downstream information from the downstream provider is recorded in association with information from the upstream entity.

According to another aspect of the invention, a method is executed in which information pertaining to an asset is gathered. The information is associated with an identification code designating the asset, independent of any transaction. Next, the information is transmitted to the centralized asset tracking datastore. Next, the asset is passed to a downstream entity. Finally, information gathered and associated with a unique identification code is retrieved from the centralized asset tracking datastore. The information is, in turn, associated with the asset, by a downstream entity.

According to another aspect of the invention, a product that has been handled in an asset-based information tracking supply chain includes an asset and a unique identification code encoded upon a medium attached to the asset. The unique identification code corresponds to a web page for presenting information related to the asset.

According to another aspect of the invention, a system for storing and making available asset-related information includes a datastore, configured and arranged to store information related to an asset as an information set. The system also includes a server in communication with the datastore. The server is configured and arranged to implement a definition of a webpage. The webpage is defined so as to require webpage to be populated with at least a subset of the information set stored in the datastore. The webpage is uniquely associated with the asset. The system also includes a network configured and arranged to provide information connectivity between the server and business systems possessed by the entities comprising the supply chain.

### BRIEF DESCRIPTION OF THE DRAWINGS

FIG. 1 depicts a system of connecting together multiple business computing systems.

FIG. 2 depicts a timeline upon which three transactions and one operation are temporally related.

FIG. 3 depicts a supply chain and also depicts a system for asset-based information tracking.

FIG. 4 depicts a method by which an upstream supplier and a downstream supplier may utilize asset-based information tracking, according to one embodiment of the invention.

FIG. 5 depicts a set of Universal Resource Locators (URLs), each of which is used to identify an asset and to associate that asset with a web page dedicated to storing and presenting information regarding the asset.

FIG. 6 depicts another method by which an upstream supplier and a downstream supplier may utilize asset-based information tracking, according to one embodiment of the invention.

FIG. 7A depicts another method by which an upstream supplier and a downstream supplier may utilize asset-based information tracking, according to one embodiment of the invention.

FIG. 7B depicts another method by which an upstream supplier and a downstream supplier may utilize asset-based information tracking, according to one embodiment of the invention.

FIG. 8 depicts another method by which an upstream supplier and a downstream supplier may utilize asset-based information tracking, according to one embodiment of the invention.

### DETAILED DESCRIPTION OF THE INVENTION

The invention disclosed herein is a system and method for storing and making available information that relates to an asset associated with a supply chain. An asset may include or be represented by any item, tangible or intangible, which may be passed among parties. A supply chain may include a set of entities called “supplier entities,” each of which either receive an asset from another supplier entity and/or passes an asset to another supplier entity. For example, a supply chain may include, without limitation, a supplier of a raw good, the supplier of a component part, a manufacturer, a distributor, a service provider, and an end consumer, each of which are examples of supplier entities.

Traditional methods of keeping track of information relating to assets have been based around transactions or operations. Transactions and operations may be referred to generically as “data generation events”. In other words, under existing approaches, as an asset changes hands or has an operation performed upon it, information regarding the transaction that caused the asset to change hands or information regarding the operation causing the asset's value to change is recorded. Thus, to unearth information about a particular asset, one would have to search an information archive armed with knowledge of the various transactions or operations of which a particular asset has been the subject. The invention presented herein permits a party in possession of an asset to be able to unearth information about that asset armed only with knowledge derivable from the asset itself.

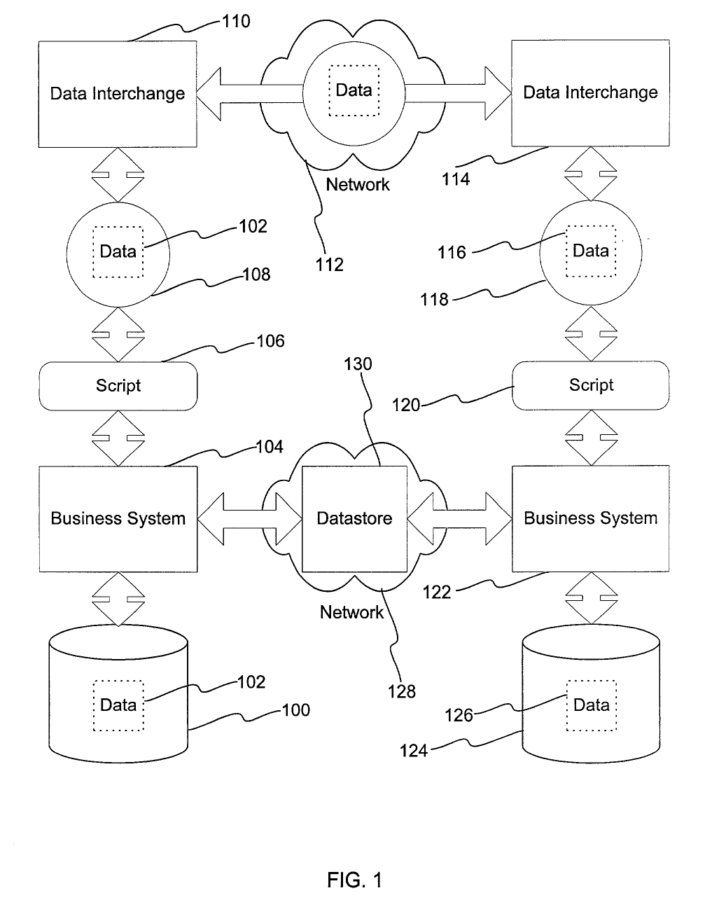

Because information concerning an asset will be determined and created by many supplier entities within a supply chain, it is desirable that the computing business systems of various members of a supply chain be in some fashion connected together to permit easy accumulation of and access to the information. FIG. 1 illustrates a system of connecting together multiple business computing systems. The system of connection includes at least two approaches that can be used alone or in combination.

As can be seen from FIG. 1, a business computing system 104 draws upon information in database 100 to perform its business related calculations and functions. Likewise, business system 122 draws upon database 124 to acquire the information necessary to perform its business related calculations and functions. FIG. 1 presents various methods of exchanging information from business system 104 to business system 122, in order that business system 122 might perform calculations and functions based upon business information held in one or both of database 124 and database 100.

In FIG. 1, an information element 102 is shown as being stored within database 100. Business system 104 draws upon database 100 to retrieve information element 102, so that it can perform a business related calculation or function. Assuming that business system 104 wished to make information element 102 available to business system 122, business system 104 could be configured and arranged to communicate with a script, which serves as an intermediary between business system 104 and communication software that provides networking functionality. Such a script is depicted in FIG. 1 as script 106. Script 106 could take the form of an independent unit of software, a dynamically linkable unit of software, or a statically linkable unit of software. Script 106 is designed to receive information element 102 and encapsulate it, in some instances, in an object wrapper 108. The purpose of performing such an encapsulation is to permit business system 104 to communicate with an information interchange 110 using a standard object interface. Information interchange 110 is a computing node on a network. Information interchange 110 and business system 104 may reside on the same physical piece of computing hardware or may reside on separate units of computing hardware that are in communication with each other.

As can be seen from FIG. 1, once information element 102 is encapsulated in object wrapper 108, the information element may be communicated across a network 112 to another information interchange 114. Network 112 may include local area networks, metropolitan area networks, campus-based networks, and wide area networks, such as the Internet. Information interchange 114 and script 120 perform effectively the inverse operations as script 106 and information interchange 110. In other words, information interchange 114 and script 120 cooperate to take information element 116, which is encapsulated in object wrapper 118, and remove information element 116 from object wrapper 118, so that business system 122 may receive information element 116 in a manner comprehensible to business system 122. Information interchange 114, script 120 and business system 122 may take the same forms as information interchange 110, script 106 and business system 104, respectively. Business system 122 may receive information element 116 and store information element 116 in a storage facility 124 as information element 126. Information element 126 thus becomes available to business system 122 for use in its business calculations and operations.

As is evident from FIG. 1, one result of linking two business systems 104, 122 in this fashion is that multiple versions of the same information are maintained in separate information storage facilities 100, 124. As a result, if business system 104 were to alter information element 102, such alteration would have to be communicated to business system 122, or else information element 102 and information element 126 would no longer represent the same information (i.e., the information elements would no longer be synchronized). Additionally, any alterations to business system 104 or business system 122 may result in the necessity of redesigning script 106 or script 120. Similarly, for each additional business system added to the information sharing arrangement presented in FIG. 1, a new script must be written to permit that new business system to communicate with a standard object interface used by each of the information interchanges.

An alternative method of connecting business system 104 and business system 122 is to network each business system 104, 122 to a common datastore 130. Each business system 104, 122 accesses the information stored in datastore 130 to perform its business functions and calculations. Accordingly, under such a system, information replication is minimized and so, too, is the effort to synchronize information after it is altered in a particular storage facility. Preferably, the central datastore 130 is accessable via the World Wide Web, the Internet, or an intranet, thereby permitting universal access to the datastore 130 without necessitating the creation of intermediary scripts. The centralized datastore approach to connecting business systems may be used as an alternative to the standard object interface approach discussed above or may be used as a supplement to that approach.

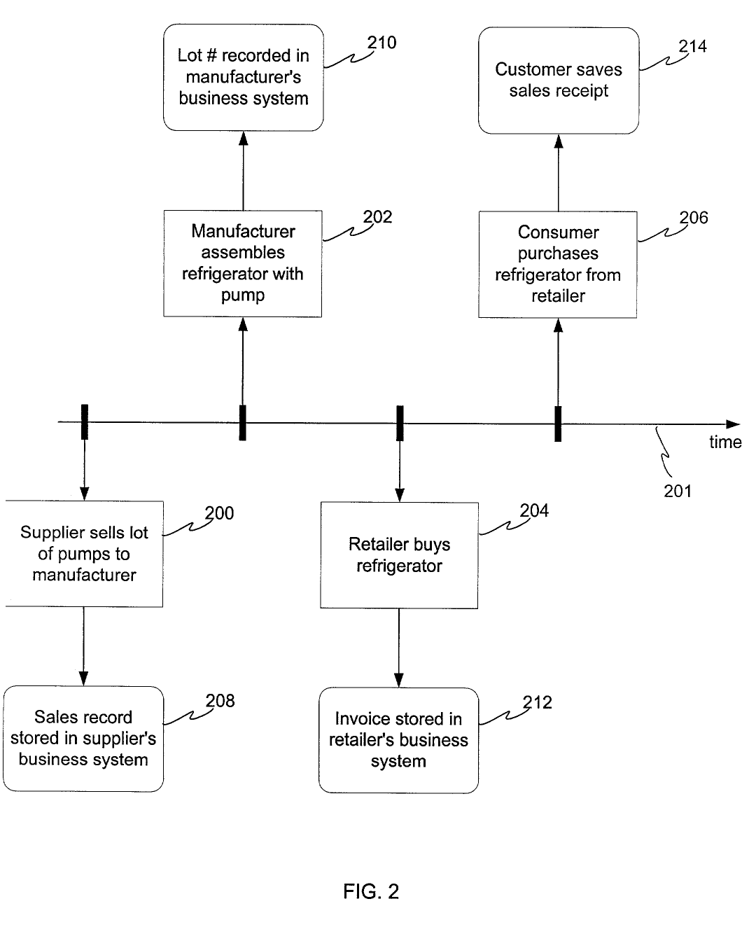

Turning to how business systems organize and associate their information, FIG. 2 illustrates the principle that information regarding an asset may be organized either based upon transactions in which the asset was involved or based upon the asset itself. These two methods of organizing and associating the information may be used as alternatives or may be used in a supplemental fashion.

FIG. 2 depicts a timeline 201 upon which three transactions 200, 204, and 206 and one operation 202 are temporally related. The transactions 200, 204, and 206 and operation 202 depicted in FIG. 2 present an exemplary situation in which a compression pump is sold by a supplier to a manufacturer of a refrigerator. The manufacturer, in turn, installs the pump within a particular refrigerator that is sold to a distributor and ultimately to an end consumer. This operation and series of transactions are depicted by: (a) transaction 200, in which a supplier sells a lot of pumps to a manufacturer; (b) operation 202, in which a manufacturer assembles a refrigerator using one of the pumps from the sold lot; (c) transaction 204, in which a distributor purchases a refrigerator from the manufacturer; and (d) transaction 206, in which a consumer purchases a refrigerator from a distributor.

Assuming a transaction/operation-based information tracking system is employed to track asset information about the pump (which is an example of an asset), the supplier records its sale of the pump in its own business system (as shown in storage operation 208) when it sells the pump to the manufacturer (as shown in transaction 200). Likewise, when the manufacturer of the refrigerator installs the pump in a refrigerator (as shown in operation 202), thereby adding value to both the pump and the refrigerator, the lot number of the pump is recorded in the manufacturer's business computing system (as shown in storage operation 210) in association with the serial number that identifies the refrigerator. Next, the retailer, when buying the refrigerator from the manufacturer (as shown in transaction 204), stores a record of the invoice in the distributor's business system (as shown in storage operation 212). Finally, when the consumer purchases the refrigerator from the retailer (as shown in transaction 206), the consumer saves the sales receipt in his personal records (as shown in storage operation 214).

The repercussions of such an information storage method can be illustrated by assuming a scenario in which the pump inside of a customer's refrigerator malfunctions, causing the customer to inquire whether the pump is under a warranty. In such a scenario, the customer may begin his inquiry by finding his sales receipt to determine which store the refrigerator had been purchased from. Taking the receipt to the particular store from which the refrigerator was purchased, the customer would make an inquiry of the store to determine whether or not the pump in the refrigerator was under store or manufacturer warranty. The store, having access only to the invoice record stored in its business system during storage operation 212, would know only the information found in a typical invoice. Thus, the store would be forced to contact the manufacturer of the refrigerator armed with only the knowledge of an invoice identification number or perhaps a serial number identifying the refrigerator. The manufacturer would be required to track the invoice identification number or refrigerator serial number back to the pump lot number recorded in its business computing system in storage operation 210, but would be forced to contact the supplier to inquire of it what, if any, warranty policy was in place for that particular lot number of pumps. The supplier would then check its business system for the record of its sale to the manufacturer to determine the date upon which the sale took place and therefore which warranty policy was in place. As can be seen, in order for the consumer to know if the pump in his refrigerator was under warranty, the customer and other supplier entities would have to be able to reconstruct the series of transactions and operations in which the refrigerator was involved. If the entities were unable to reconstruct any one of the transactions or operations, the customer would be unable to determine whether or not the pump was under warranty.

In an embodiment of the present invention, the information can be organized around the pump and/or refrigerator, instead of organizing the information around the transactions and operations that were visited upon the pump and/or refrigerator. Such a system would be an asset-based information tracking system. An asset-based information tracking system permits a party in possession of an asset to gain information about the asset without having to reconstruct the series of transactions visited upon the asset. An assset-based system may also identify constituent assets, which are included in a larger asset (such as a compression pump in a refrigerator).

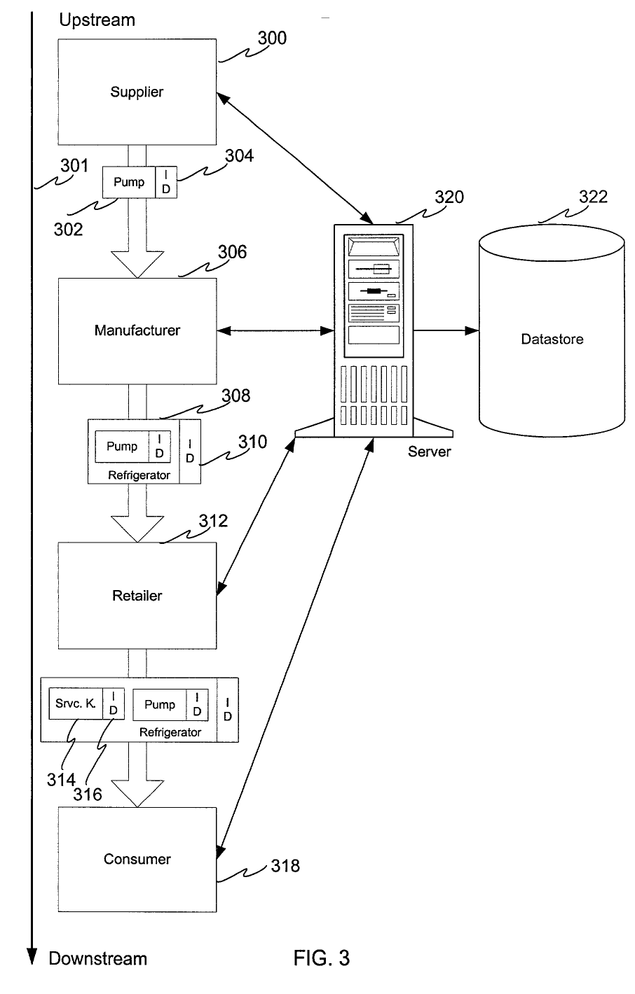

FIG. 3 depicts the supply chain discussed in FIG. 2 and illustrates the principle of asset-based information tracking. In FIG. 3, the supply chain is shown as consisting of a supplier 300, a manufacturer 306, a retailer 312, and a consumer 318. The supply chain is characterized by upstream members (also referred to as “supplier entities”) and downstream members (also referred to as “supplier entities”), wherein the upstream direction is the direction from which an asset flows, and the downstream direction is the direction in which the particular asset flows, as shown by arrow 301. Stated another way, as an asset flow from the supplier 300 to the consumer 318, it is flowing downstream.

While in the hands of supplier 300, pump 302 is given a unique identification code 304. Pump 302 and identification code 304 remain in association for the life of the asset. As supplier 300 gathers and generates information about the pump 302, that information is stored in association with the identification code 304. As can be seen in FIG. 3, the information regarding the pump 302 (also referred to as “asset information”) can be stored centrally in a datastore 322, which is accessed via a server 320 that is, in turn, accessible to the supplier 300 via a network. For example, warranty information regarding an asset may be stored centrally in datastore 322. Under this approach, information regarding the pump 302 is stored in the datastore 322 in association with the unique identification code 304. Such information might include testing information, sales information, warranty information, maintenance manuals and records or any other form of information collected and/or generated by the supplier 300. A supplier may maintain some information in its own database, however. Notably, as the pump 302 is sold from supplier 300 to the manufacturer 306, unique identification code 304 remains in association with pump 302.

A unique identification code may be associated with an asset, such as a pump 302, by printing the code on the asset, printing the code on a medium attached to the asset such as a tag, printing the code on packaging encompassing the asset, by encoding the identification code on a magnetic strip attached to the asset or attached to packaging associated with the asset, by encoding the unique identification code on an optical strip attached to the asset, by encoding the information on an optical strip attached to packaging associated with the asset, by encoding the information in a barcode attached to the asset, or by any other means. A unique identification code may be associated with an asset, such as a pump 302, by affixing the code to the asset or to a tag attached to the asset. “Affixing” includes at least the following processes: printing the code; etching the code; magnetically encoding the code; encoding the code on a transducer attached to an asset; optically encoding the code; or encoding the code via a radio frequency tag. Thus, the unique identification code describing the pump becomes derivable based upon possession of the pump itself.

When manufacturer 306 receives the pump 302 from supplier 300, the manufacturer 306 installs the pump 302 into a refrigerator 308. The pump 302 remains associated with the unique identification code 304 and becomes a constituent asset of the refrigerator 308 (which is, itself, an asset). Manufacturer 306 associates a new unique identification code 310 with the refrigerator 308. Manufacturer 306 stores information gathered or generated with respect to pump 302 in association with identification code 304 and information generated or gathered with respect to refrigerator 308 in association with unique identification code 310. These sets of information are transmitted to the server 320 for storage in the central datastore 322.

If new information regarding the pump 302 is generated or gathered by manufacturer 306, the new information is stored in the central datastore 322 in association with unique identification code 304. Similarly, information regarding the refrigerator 308 is stored in association with its unique identification code 310 in the central datastore 322. An association or link between unique identification code 310 and unique identification code 304 is also stored in the central datastore 322. This link or association permits an entity accessing information about either the pump 302 or the refrigerator 308 to recognize that the pump 302 is installed in refrigerator 308 or that the refrigerator 308 contains the pump 302.

By virtue of the link or association, a possessor of the refrigerator 308 is able to derive the first unique identification code 304 (the unique identification code associated with the pump), based upon possession of the refrigerator 308 only. For example, a possessor of refrigerator 308 may be able to determine its unique identification code 310 by reading the code off of a tag associated with the refrigerator 308, or by magnetically scanning it off of a magnetic strip attached to refrigerator 308. Once in possession of the refrigerator's unique identification code 310, a party could access information regarding refrigerator 308 from the central datastore 322 by making a request of the server 320 with unique identification code 310. The information returned from the server 320 would indicate an association or a link between unique identification code 310 and unique identification code 304 (which is associated with the pump 302). Thus, the possessor of the refrigerator is permitted to view information regarding its pump (including the pump's warranty information), which was originally originally collected and entered into the database 320 by supplier 300.

When the refrigerator 308 and its constituent pump 302 are purchased by the retailer 312, the refrigerator 308 and pump 302 remain in association with their respective unique identification codes. The retailer 312 is free to generate more information about either the refrigerator 308 or the pump 302, and the retailer 312 may store that information, in association with their respective identification codes, via a server 320 in the datastore 322. The retailer 312, being a supplier entity within the supply chain, is also free to generate another asset in association with either the refrigerator 308 or the pump 302, and retailer 312 may form another unique identification code to identify that asset. Any such new identification code will be linked or associated with the unique identification codes 304, 310, which identify the pump 302 and the refrigerator 308, respectively.

In the example depicted in FIG. 3, the retailer 312 creates an intangible asset, a service contract 314, which is associated with the refrigerator 308. The service contract 314 is identified by a unique identification code 316. Information regarding the service contract 314 is stored in the central datastore 322 in association with the unique identification code 316. The unique identification code 316 is associated or linked with identification code 310, which identifies the refrigerator 308, and optionally with the unique identification code 304, which identifies the pump.

When the consumer 318 ultimately purchases the refrigerator 308 from the distributor 312, the consumer 318 becomes in possession of the unique identification code 310 that identifies the refrigerator 308. Based on this identification code, the consumer 318 is able to derive information about the refrigerator 308 and each of its associated constituent assets, such as the service contract 314 and the pump 302. Notably, the unique identification code 316 for the service contract 314 may be discoverable only by using the unique identification code 310 for the refrigerator to gather information regarding the refrigerator (such a query would return a link to the service contract 314). Alternatively, the unique identification code 316 for the service contract 314 may be printed upon the service contract 314, itself.

As is illustrated in FIG. 3, in an asset-based information tracking system, a unique identification code identifies the particular asset throughout the lifecycle of the asset, and information regarding the asset is stored in association with that unique identification code throughout the lifecycle of the asset. Furthermore, associations or links between associated assets, such as a pump within a refrigerator, or a service contract covering a refrigerator and its constituent assets, are maintained so that information about any one of the associated assets may be derived based upon the unique identification code of any one of the other associated assets.

Using such a system, the consumer 318 may take a broken refrigerator 308 to a repair shop for repair of a broken pump 302. The repair shop may enter repair information about the broken pump 302 in association with any appropriate identification code (e.g., unique identification code 304 and unique identification code 310). The supplier 300 of the pump 302 may deduce information regarding the performance of its pumps by keeping track of its identifications codes, such as unique identification code 304, and periodically searching for additional information gathered by downstream supplier entities and stored in association with unique identification number 304. Thus, the repair shop, for example, may become part of the supply chain when the repair shop supplies an intangible asset to the refrigerator (i.e., a maintenance asset). Likewise, the repair shop may also supply tangible assets, such as replacement parts to the refrigerator.

Although FIG. 3 shows a supplier entity 300, manufacturer entity 306, distributor 312 and consumer entity 318 individually connected to server 320, it is understood by one skilled in the art that one or more of these entities may be connected to server 320 via a shared network, rather than a dedicated line. An example of a shared network may be a consumer 318 or repair shop connecting to server 320 via the Internet. As such, any entity may be connected via a shared network.

The operators of server 320 and datastore 322 may charge one or more members of the supply chain for access to the information regarding each of the assets. Additionally, a particular supplier entity may designate some of its information as “public” and some of its information as “private”, so that a future holder of its asset (who is thereby in possession of that asset's unique identification code) is able to view only the information designated as public, rather than all of the information regarding that asset. In another embodiment of the invention, various supplier entities may pay varying rates to gain greater access to various levels of information stored by other members of a supply chain.

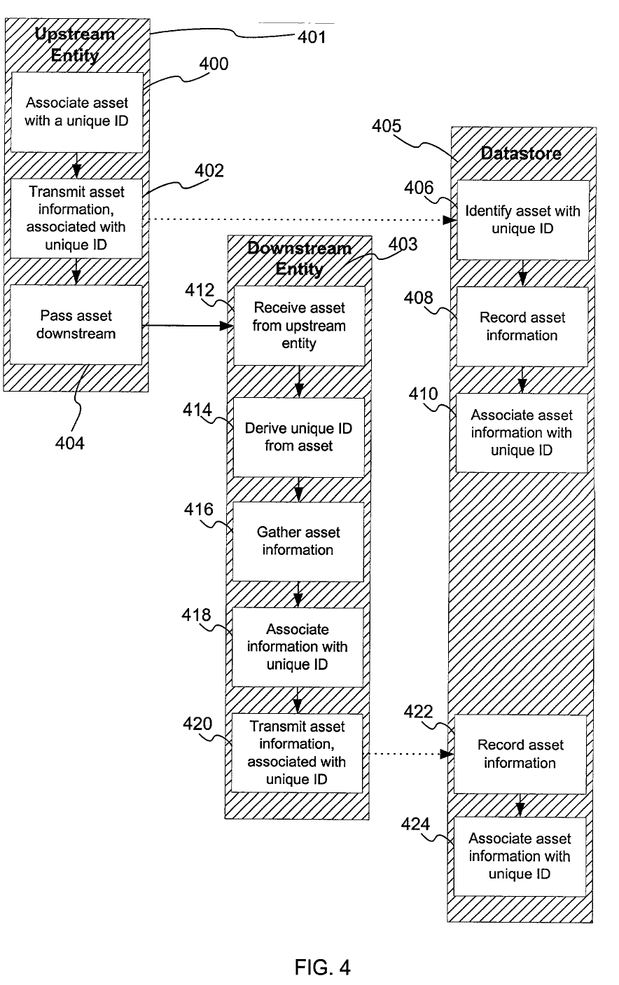

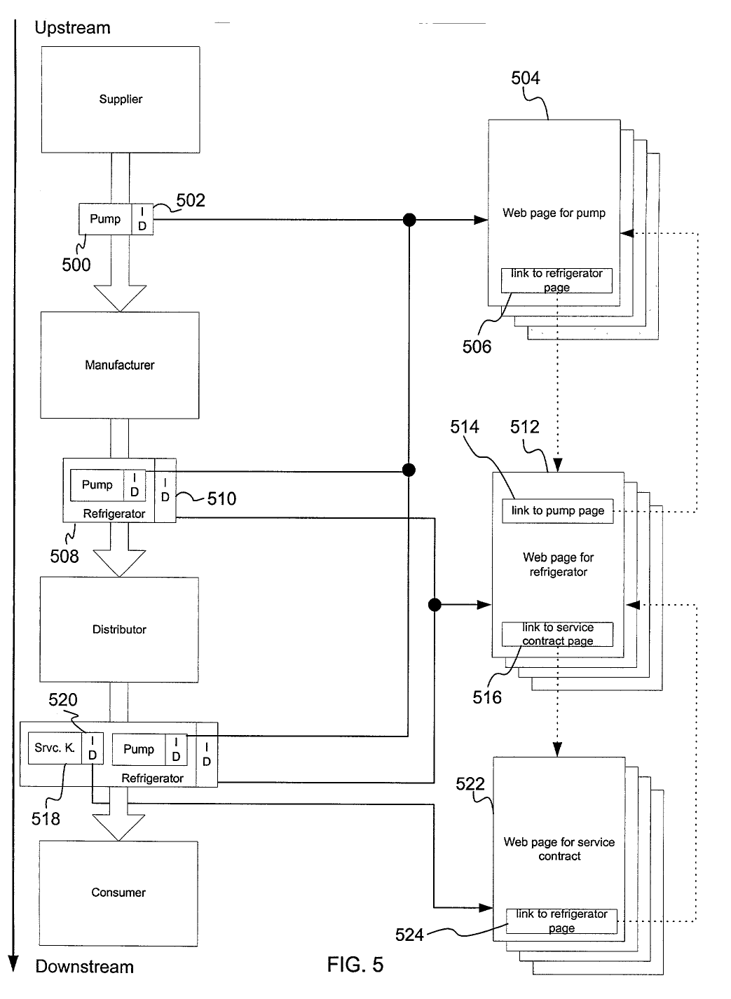

FIG. 4 illustrates the broad principle that an asset originally handled or created by an upstream entity is assigned a unique identification code that remains with the asset throughout the asset's lifecycle. Further, even while the asset is handled by a downstream entity, that same unique identification code remains in force, so that additional information gathered by the downstream entity can be recorded in association with that same unique identification code. In operation 400, an asset is created (e.g., a pump is assembled) and a unique identification code is associated with the asset. The unique identification code may be attached to or affixed to the asset. For example, a magnetically or optically scannable strip containing an identifying code may be attached to a compression pump. Next, in operation 402, information about the asset is transmitted in association with the unique identification code, and in operation 404, the upstream entity 401 passes the asset to a downstream entity. Further description regarding transmitting information in association with a unique identification code (as in operation 402) is presented in the discussion associated with FIG. 5.

Transmission operation 402 initiates a series of operations by datastore 405. The first operation 406 internally identifies the asset with the unique identification number. Next in operation 408, the information transmitted to the datastore 405 by the upstream entity is recorded in an information storage facility, and finally in operation 410, the recorded information is associated with the unique identification code so that such information can be retrieved by any entity in the supply chain by providing the datastore 405 with the unique identification code. Further description regarding identifying an asset with a unique identification code (as in operation 406), recording information in a storage facility (as in operation 408), and associating stored information with a unique identification code (as in operation 410) is presented in the discussion associated with FIG. 5.

The downstream supplier entity 403 receives the asset from the upstream supplier entity 401 in operation 412 and derives from the asset the unique identification code (this action is shown in operation 414) assigned to that asset by the upstream entity in operation 400. Subsequently, in operation 416, the downstream entity gathers additional information about the asset. In operation 418, this information is associated with the unique identification code derived in operation 414 and is transmitted, as shown in transmission operation 420, in association with that unique identification code. In operation 422, the datastore records the newly received asset information and, once again, associates that asset information with the same unique identification code in operation 424. Accordingly, all of the information gathered with respect to the asset by the upstream entity and the downstream entity may be stored in the datastore in association with the unique identification code assigned to the asset by the upstream entity in operation 400, although other embodiments employing alternate information configurations are contemplated within the scope of the present invention.

FIG. 5 illustrates the principle that each unique identification code associated with an asset can be a Universal Resource Locator (URL) and that the information associated with each asset, and therefore with each unique identification code, can be presented in a webpage or taxonomy of webpages referenced by the URL. Returning to our example of the refrigerator with its constituent pump and service contract, it can be seen that pump 500, with unique identification code 502, has a webpage 504 which presents the information gathered by supplier, manufacturer, distributor and consumer with respect to the pump 500. Unique identification code 502 is a URL pointing to webpage 504.

Similarly, refrigerator 508 has a unique identification code 510, which is a URL pointing to a webpage 512 or taxonomy of webpages containing information regarding the refrigerator. The association or link referred to above between unique identification code 502 and unique identification code 510 is presented, in this embodiment, as a hyperlink 506 from the pump webpage 504 pointing to the refrigerator webpage 512, and is also presented as a hyperlink 514 from the refrigerator webpage 512 pointing to the pump webpage 504. Likewise, service contract 518 is associated with unique identification code 520, which is a URL pointing to a service contract web page 522. Because the service contract 518 is a constituent asset of refrigerator 508, a link or association between the unique identification codes 510 and 520 is represented as a hyperlink 524 from the service contract web page 522 to the refrigerator webpage 512 and is also represented as a hyperlink 516 from the refrigerator webpage 512 to the service contract webpage 522. Similar hyperlinks may optionally exist between the pump webpage 504 and the refrigerator webpage 522.

In this embodiment, the server 320 presented in FIG. 3 and datastore 322 may be embodied as an active server communicating with a database as its back end. The active server 320 constructs webpages 504, 512 and 522 based upon the information stored for each asset in the database 322 on its back end.

With respect to FIG. 4, the act of transmitting collected asset information in association with a unique identification code (such as in operation 402) may comprise transmission of a hypertext transmission protocol (http) request, formulated on the basis of a user having entered (either manually or via automation) asset data into a web page designed to receive the asset data. Further, the act of recording information pertaining to the asset in an independent datastore (such as in operation 408) may consist of creating a record within the database and entering asset information provided by the upstream entity into the record. Additionally, the act of identifying the asset with the unique identification code (such as in operation 406) comprises assigning the URL (which is the unique identification code) to a webpage or taxonomy of webpages intended to hold information corresponding to the asset. Finally, operation 410, in which the recorded information from the upstream supplier entity is associated with the unique identification code, comprises constructing a definition for the webpage such that the webpage is populated with at least a subset of the information recorded in operation 408. Such a definition may be written in cold fusion markup langue (CFML), dynamic hypertext markup language (DHTML), HTML, XML, any other suitable markup language, or may be embodied as an active server page.

Continuing to examine FIG. 4 in light of embodying the invention as a web-based system, operation 422, in which the information pertaining to the asset is recorded in the database, would comprise opening the record for the asset within the database and entering the information provided by the downstream supplier entity into the record. Lastly, association operation 424 would comprise constructing a definition for the webpage such that the webpage is populated with at least a subset of the information recorded in operation 422.

In addition to a unique identification code being a URL pointing to a webpage or taxonomy of webpages dedicated to an asset, the URL may point to any other type of resource. For example, the URL may point to an application, a movie file, an image file, a sound file, or a JAVA application.

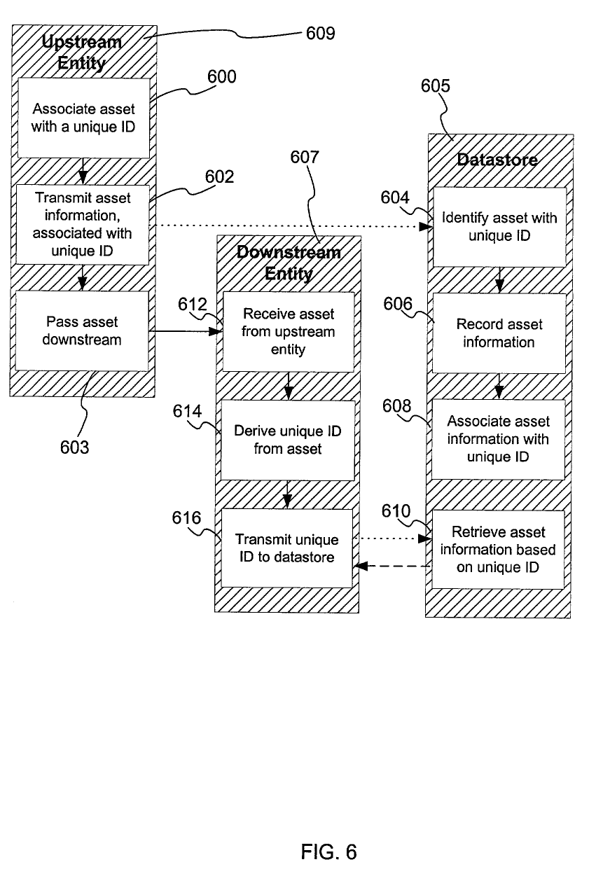

FIG. 6 illustrates the principle that asset information transmitted to the datastore 605 by an upstream supplier entity 609 may be retrieved at a later point by a downstream entity. The process in FIG. 6 commences with the upstream entity 609 associating a unique identification code with an asset in operation 600. Next in operation 602, information regarding the identified asset is transmitted to the datastore 605 in association with the unique identification code. As suggested in FIG. 5, and as may be the case in FIG. 4, the operation of transmitting asset information in association with a unique identification code may comprise entering the asset information into a webpage designed to input information for the particular asset. Thus, the webpage acts as an interface, or front end, for an database serving as the back end of the datastore. Finally in operation 603, the upstream entity 609 passes the asset to the downstream entity.

The datastore 605, in response to receiving the transmitted asset information from the upstream entity, runs through operations 604, 606 and 608 which are similarly disclosed in FIG. 4 as operations 406, 408 and 410. In these operations, the datastore 605 internally identifies the asset with the unique identification code, records the asset information into an database and associates the asset information with the unique identification code. As explained with reference to FIG. 5, these steps may involve opening a record in an database, entering asset information into the record, constructing a webpage definition which uses at least a subset of the information entered into the database, and assigning the webpage a URL matching the unique identification code traveling with the asset.

The downstream entity 607 commences its involvement with the asset by receiving it from the upstream entity in operation 612. Next, in operation 614, the downstream entity 607 derives the unique identification code from the asset. Finally in operation 616, the downstream entity 607 transmits the unique identification code to the datastore 605. The transmission of operation 616 may comprise sending a message or HTTP request to a server providing access to the datastore 605. Thus, a URL that is a unique identification code of the asset may be typed or scanned into a web browser to thereby initiate the HTTP request. In operation 610, the datastore 605 responds to this transmission by retrieving the asset information, based upon the unique identification code. Operation 610 may comprise dynamically constructing a webpage based upon the URL requested and the information stored in the database on its back end.

As can be seen from FIG. 6, the downstream entity 607 is able to retrieve asset information gathered or created by the upstream entity 609 and stored in the datastore. The downstream entity 607 is able to access this information by virtue of its possession of the asset since the unique identification code is derivable from mere possession of the asset.

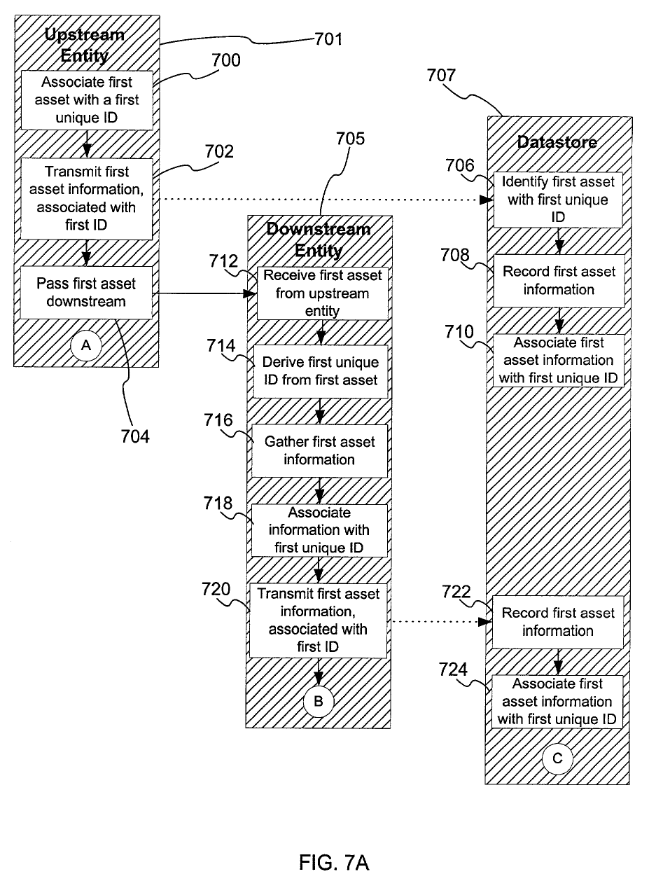

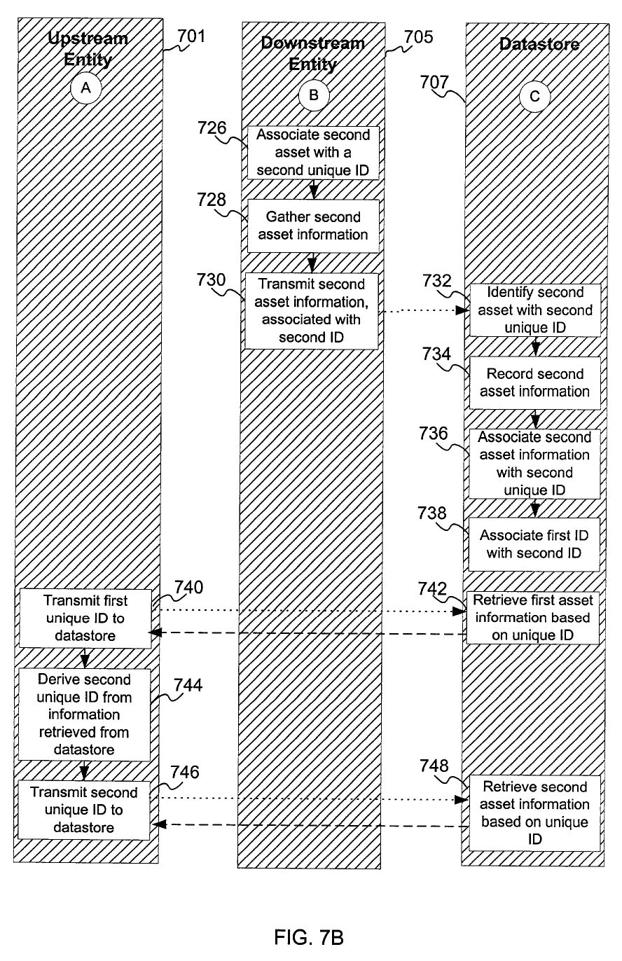

FIG. 7A illustrates the principle that a second asset that is a constituent of a first asset may be associated with the first asset. In FIG. 7A, the upstream entity 701 first associates a unique identification code with the first asset in operation 700, and then in operation 702 transmits information regarding the first asset to the datastore in association with the first unique identification code. Finally, the upstream entity 701 passes the asset to the downstream entity 705 in operation 704. The datastore 707 responds in operation 706 by internally identifying the first asset with the first unique identification code. Subsequently, in operation 708, the datastore 707 records the first asset information, and then associates the first asset with the first unique identification code in operation 710.

The downstream entity 705 commences its involvement with the asset when it receives the first asset from the upstream entity 701 in operation 712. Next, in operation 714, the downstream entity 705 derives the first unique identification code from the first asset. The downstream entity 705 proceeds on to gather further information about the first asset in operation 716, and in operation 718, the downstream entity 705 associates the new information with the first unique identification code. Next, in operation 720, the new information regarding the first asset is transmitted in association with the first unique identification code to the datastore 707. The datastore 707 responds in operation 722 by recording the information regarding the first asset. Additionally, in operation 724, the datastore 707 associates the recorded information with the first unique identification code.

FIG. 7B is an illustration of a continuation of the interplay between the upstream entity 701, the downstream entity 705, and the datastore 707. As can be seen, the “A” at the top of the upstream entity box in FIG. 7B marks continuation with the activities of the upstream entity 701 preceding in FIG. 7A. Likewise, the “B” at the top of the downstream entity box in FIG. 7B indicates continuation with the activities of the downstream entity 705 preceding in FIG. 7A, and the “C” at the top of the datastore box indicates similar continuation.

Returning to the activities of the downstream entity 705, the downstream entity 705 associates a second asset with a second unique identification code in operation 726. In this case, the second asset is an asset in association with the first asset. For example, the second asset may be an asset that is a constituent of the first asset, such as the plump and refrigerator or the service warranty for the refrigerator. In operation 728, downstream entity 705 gathers information about the second asset, and proceeds to transmit that information in operation 730 to the datastore. The transmission of operation 730 is done in association with the second identification code.

In operation 732, the datastore 707 internally identifies the second asset with the second unique identification code and records the asset information regarding the second asset in operation 734. Next, in operation 736, the datastore 707 associates the information regarding the second asset with the second unique identification code. Finally, in operation 738, an association is formed between the first identification and the second identification code (this may be accomplished with hyperlinks as described above).

Operation 740 shows that after the upstream 701 and downstream 705 entity have recorded asset information about the first and second assets, respectively, the upstream entity 701 is able to transmit the first unique identification code to the datastore 707, thereby prompting the datastore to retrieve information about the first asset in operation 742. As mentioned earlier, this step may comprise the simple entering of a URL into a web browser, thereby triggering the construction of a dynamic webpage regarding the first asset. Next, in operation 744, the upstream entity 701 derives the second unique identification code based upon the information returned from the datastore 707 in operation 742. For example, in the embodiment wherein datastore 707 provides a webpage regarding information concerning the first asset, such webpage would contain a hyperlink pointing to the second asset's webpage. In other words, the hyperlink would contain the URL of the second asset's webpage. Thus, by capturing the URL of the second asset's webpage, the second unique identification code is captured, because the URL for the second asset's webpage and the second unique identification code are one and the same. Next, in operation 746, the upstream entity 701 transmits the second unique identification code to the datastore 707, causing the datastore 707 in operation 748 to return the asset information regarding the second asset. Thus, once it has once derived the identification code for the second asset, the upstream entity 701 is able to directly access information regarding constituent assets without having to first examine information about the primary asset.

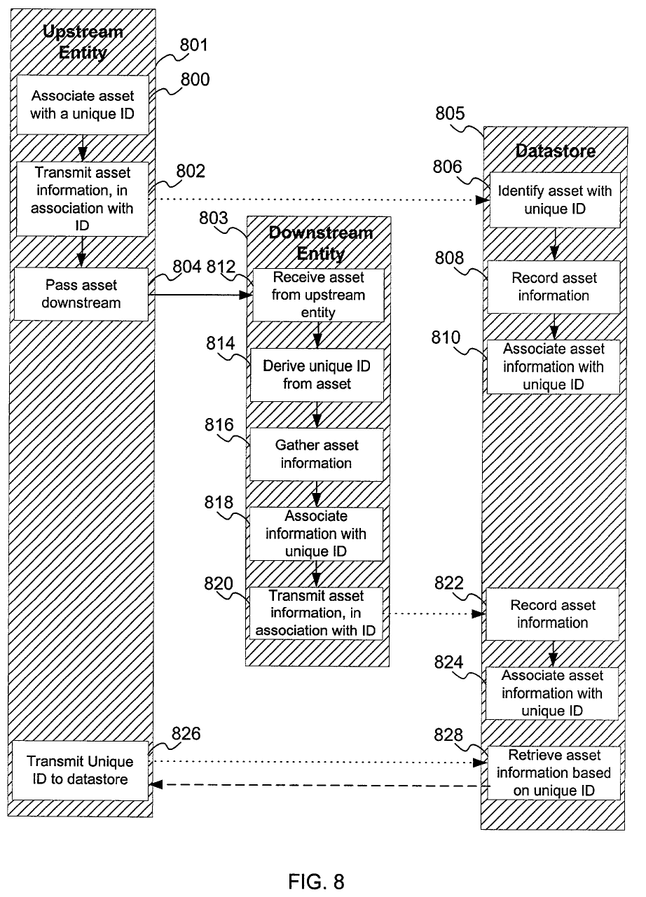

FIG. 8 illustrates the principle that the invention can be used by an upstream entity 801 to retrieve information about one of its assets entered into the datastore by a downstream entity 803. In this method of use, the upstream entity 801 begins by associating a unique identification code with the asset in operation 800. Subsequently, in operation 802, the upstream entity 801 transmits asset information to the central datastore, in association with the unique identification code. Finally in operation 804, the upstream entity 801 passes the asset to a downstream entity.

As has been described several times above, the datastore 805 in operation 806 responds to the transmission in operation 802 by internally identifying the asset with a unique identification code in operation 806, recording the asset information in operation 808, and associating the recorded information with the unique identification code in operation 810.

The downstream entity 803 begins its involvement with the asset by receiving the asset from the upstream entity 801 in operation 812. Next, the downstream entity 803 derives the unique identification code from the asset in operation 814 and proceeds on to gather additional information about the asset in operation 816. In operation 818, the newly gathered information is associated with the unique identification code, and in operation 820, the asset information is transmitted to the datastore 805 in association with the unique identification code. In operation 822, the datastore 805 responds by recording the asset information, and associating the recorded asset information with unique identification code (shown in operation 824). As can be seen, both the upstream entity 801 and the downstream entity 803 have recorded information about the asset into the central datastore 805, in association with the unique identification code. Accordingly, the upstream entity 801, in operation 826, is able to transmit the unique identification code to the datastore 805 thereby retrieving all of the information about the asset, including the information originally recorded by the upstream entity and the information recorded by the downstream entity in operations 820 and 822.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification. The claims are intended to cover such modifications and devices.

The claimed invention is:

1. A method for managing asset tracking information related to an asset within a supply chain, the supply chain comprising a plurality of supplier entities capable of accessing a centralized asset tracking datastore, the method comprising:
(a) recording information pertaining to the asset in an independent datastore, the information being provided by an upstream supplier entity;
(b) identifying the asset with a unique identification code;
(c) associating the recorded information from the upstream supplier entity with the unique identification code;
(d) recording information pertaining to the asset in the independent datastore, the information being provided by a downstream supplier entity; and
(e) associating the recorded information from the downstream supplier entity with the unique identification code.

2. The method of claim 1, wherein act (a) comprises:
creating a record within a database; and
entering information provided by the upstream supplier entity into the record.

3. The method of claim 2, wherein act (b) comprises:
identifying the asset with a unique Universal Resource Locator (URL), the URL corresponding to a resource.

4. The method of claim 3, wherein:
the resource comprises a webpage; and
act (c) comprises constructing a definition for the webpage, such that the webpage is populated with at least a subset of the information in the record.

5. The method of claim 4, wherein act (d) comprises:
opening the record within the database; and
entering information provided by the downstream supplier entity into the record.

6. The method of claim 5 wherein act (e) comprises:
constructing a definition for the webpage, such that the webpage is populated with at least a subset of the information provided by the downstream supplier.

7. A method for managing asset tracking information related to an asset within a supply chain, the supply chain comprising a plurality of supplier entities capable of accessing a centralized asset tracking datastore, the method comprising:
(a) recording information pertaining to a first asset, the information being provided by an upstream supplier entity;
(b) identifying the first asset with a first unique identification code;
(c) associating the recorded information from the upstream supplier entity with the first unique identification code;
(d) recording information pertaining to a second asset, the information being provided by a downstream supplier entity, the second asset possessing the first asset as a constituent;
(e) identifying the second asset with a second unique identification code;
(f) associating the recorded information from the downstream supplier entity with the second unique identification code; and
(g) associating the first unique identification code with the second unique identification code.

8. The method of claim 7, wherein act (b) comprises:
identifying the first asset with a first unique Universal Resource Locator (URL), corresponding to a first resource.

9. The method of claim 8, wherein act (e) comprises:
identifying the second asset with a second unique Universal Resource Locator (URL), corresponding to a second resource.

10. The method of claim 9, wherein:
the first resource comprises a first webpage;
the second resource comprises a second webpage; and
act (g) comprises associating the first unique URL and the second unique URL with a hyperlink on the first webpage, the hyperlink pointing to the second webpage.

11. The method of claim 9, wherein:
the first resource comprises a first webpage;
the second resource comprises a second webpage; and
act (g) comprises associating the first unique URL and the second unique URL with a hyperlink on the second webpage, the hyperlink pointing to the first webpage.

12. A method for providing asset tracking information related to an asset within a supply chain, the supply chain comprising a plurality of supplier entities capable of accessing a centralized asset tracking datastore, the method comprising:
(a) receiving an asset from an upstream supplier;
(b) deriving from the asset a unique identification code;
(c) gathering information pertaining to the asset;
(d) associating the information with the unique identification code; and
(e) transmitting the information, associated with the unique identification code, to the centralized asset tracking datastore.

13. The method of claim 12, wherein act (b) comprises:
reading a Universal Resource Locator printed upon the asset.

14. The method of claim 12, wherein act (b) comprises:
reading a Universal Resource Locator printed upon a tag attached to the asset.

15. The method of claim 12, wherein act (b) comprises:
reading a Universal Resource Locator printed upon packaging associated with the asset.

16. The method of claim 12, wherein act (b) comprises:
Optically scanning a Universal Resource Locator encoded in an optically scanable format, printed on a medium associated with the asset.

17. The method of claim 12, wherein act (b) comprises:
optically scanning a Universal Resource Locator encoded in an optically scannable format, printed upon the asset.

18. The method of claim 12, wherein act (b) comprises:
magnetically scanning a Universal Resource Locator encoded in a magnetically scanable format, disposed on a medium associated with the asset.

19. The method of claim 12, wherein act (b) comprises:
magnetically scanning a Universal Resource Locator encoded in a magnetically scanable format, disposed upon the asset.

20. The method of claim 12, wherein acts (d) and (e) comprise:
entering the information into a webpage, the webpage being uniquely associated with the asset.

21. A method for accessing asset tracking information related to an asset within a supply chain, the supply chain comprising a plurality of supplier entities capable of entering information into a centralized asset tracking datastore, the method comprising:
(a) receiving an asset from an upstream supplier;
(b) deriving from the asset a unique identification code; and
(c) retrieving information related to the asset from a centralized asset tracking datastore based upon the unique identification code, the information having been gathered by an independent upstream supplier entity.

22. The method of claim 21, wherein act (b) comprises:
reading a Universal Resource Locator affixed upon the asset.

23. The method of claim 21, wherein act (b) comprises:
reading a Universal Resource Locator printed affixed to a tag attached to the asset.

24. The method of claim 21, wherein act (b) comprises:
reading a Universal Resource Locator printed upon packaging associated with the asset.

25. The method of claim 21, wherein act (b) comprises:
optically scanning a Universal Resource Locator encoded in an optically scanable format, printed on a medium associated with the asset.

26. The method of claim 21, wherein act (b) comprises:
optically scanning a Universal Resource Locator encoded in an optically scanable format, printed upon the asset.

27. The method of claim 21, wherein act (b) comprises:
magnetically scanning a Universal Resource Locator encoded in a magnetically scanable format, disposed on a medium associated with the asset.

28. The method of claim 21, wherein act (b) comprises:
magnetically scanning a Universal Resource Locator encoded in a magnetically scanable format, disposed upon the asset.

29. The method of claim 21, wherein acts (b) and (c) comprise:
deriving from t he asset a unique Universal Resource Locator (URL); and
using the URL to access a webpage uniquely associated with the asset, the webpage containing information related to the asset.

30. A method for managing asset tracking information related to an asset within a supply chain, the supply chain comprising a plurality of supplier entities capable of accessing a centralized asset tracking datastore, the method comprising:
(a) gathering information pertaining to an asset;
(b) transmitting the information to the centralized asset tracking datastore, the information being associated with the asset, independent of any particular transaction;
(c) sending the asset from an upstream entity to a downstream entity;
(d) deriving from the asset a unique identification code, in response to having received the asset;
(e) gathering downstream information pertaining to the asset;
(f) associating the downstream information with the unique identification code, independent of any particular transaction;
(g) transmitting the downstream information, associated with the unique identification code, to the centralized asset tracking datastore; and
(h) recording the downstream information from the downstream provider in association with information from the upstream entity.

31. The method of claim 30, wherein act (b) comprises:
entering the information into a webpage, the webpage being uniquely associated with the asset.

32. The method of claim 31, wherein acts (f) and (g) comprise:
entering the downstream information into the webpage.

33. A method for providing asset tracking information related to an asset within a supply chain, the supply chain comprising a plurality of entities capable of accessing a centralized asset tracking datastore, the method comprising:
(a) gathering information pertaining to an asset, said information being associated with an identification code designating the asset, independent of any transaction;
(b) transmitting the information to the centralized asset tracking datastore;
(c) passing the asset to a downstream entity; and
(d) retrieving from the centralized asset tracking datastore information gathered and associated with a unique identification code, which is, in turn, associated with the asset, by a downstream entity.

34. A product that has been handled in an asset-based information tracking supply chain, the product comprising:
an asset; and
a unique identification code encoded upon a medium attached to the asset, the unique identification code corresponding to a web page for presenting information related to the asset.

35. The product of claim 34, wherein the unique identification code encoded upon a medium comprises a magnetic strip attached to the asset and encoding a Universal Resource Locator.

36. The product of claim 34, wherein the unique identification code encoded upon a medium comprises a tag attached to the asset, the tag having the unique identification code printed thereupon.

37. The product of claim 34, wherein the unique identification code encoded upon a medium comprises an optical strip attached to the asset and encoding a Universal Resource Locator.

38. The product of claim 34, wherein the unique identification code encoded upon a medium comprises a barcode attached to the asset and encoding a Universal Resource Locator.

39. A system for storing and making available asset-related information regarding an asset within a supply chain, the supply chain comprising a plurality of entities capable of accessing a centralized datastore, the system comprising:
the datastore, configured and arranged to store information related to an asset as an information set;
a server, in communication with the datastore, the server being configured and arranged to implement a definition of a webpage, the webpage being defined so as to require webpage population with at least a subset of the information set stored in the datastore, and the webpage being uniquely associated with the asset; and
a network configured and arranged to provide information connectivity between the server and business systems possessed by the entities comprising the supply chain.

40. The system of claim 39, wherein the server is further configured and arranged to implement a definition of a webpage, the webpage being configured and arranged to contain a hyperlink pointing to a webpage uniquely associated with a second asset, the second asset being associated with the first asset.
